(19) United States
(12) Patent Application Publication
(10) Pub. No.: US 2025/0008511 A1
(43) Pub. Date: Jan. 2, 2025

(54) DATA PROCESSING METHOD AND APPARATUS AND ELECTRONIC DEVICE

(71) Applicant: Lenovo (Beijing) Limited, Beijing (CN)

(72) Inventors: Hongwei NIU, Beijing (CN); Zongqiang YU, Beijing (CN)

(21) Appl. No.: 18/758,920

(22) Filed: Jun. 28, 2024

(30) Foreign Application Priority Data
Jun. 29, 2023 (CN) 202310790620.9

(51) Int. Cl. H04W 72/1268; H04W 72/20

(52) U.S. Cl. CPC H04W 72/1268; H04W 72/20

(57) ABSTRACT

A data processing method includes receiving, during a pre-scheduling period, feedback report information for pre-scheduling information from a terminal, and in response to the report information including the task requirement information, performing a scheduling operation based on the pre-scheduling grant information according to the task requirement information. The pre-scheduling information is generated based on scheduling grant information of last task transmission of the terminal.

### CROSS-REFERENCE TO RELATED APPLICATION

The present disclosure claims priority to Chinese Patent Application No. 202310790620.9, filed on Jun. 29, 2023, the entire content of which is incorporated herein by reference.

### TECHNICAL FIELD

The present disclosure is related to the communication technology field and, more particularly, to a data processing method, a data processing apparatus, and an electronic device.

### BACKGROUND

Currently, User Equipment (UE) performs uplink task transmission with a base station. Each time when uplink data needs to be sent, and no uplink scheduling resource exists, a scheduling request needs to be sent to obtain a scheduling authorization of the base station. When the terminal performs task transmission a plurality of times, the base station needs to parse the scheduling request a plurality of times. When the parsing of the scheduling request fails or authorization resources need to be reassigned, the processing efficiency of the base station is low, which extends the time for the uplink task to obtain the scheduling authorization.

### SUMMARY

An aspect of the present disclosure provides a data processing method. The method includes receiving, during a pre-scheduling period, feedback report information for pre-scheduling information from a terminal, and in response to the report information including the task requirement information, performing a scheduling operation based on the pre-scheduling grant information according to the task requirement information. The pre-scheduling information is generated based on scheduling grant information of last task transmission of the terminal.

An aspect of the present disclosure provides a data processing apparatus, including a reception module and a scheduling module. The reception module is configured to receive, during a pre-scheduling period, feedback report information for pre-scheduling information from a terminal. The pre-scheduling information is generated based on scheduling grant information of last task transmission of the terminal. The scheduling module is configured to, in response to the scheduling module report information including the task requirement information, perform a scheduling operation based on the pre-scheduling grant information according to the task requirement information.

An aspect of the present disclosure provides an electronic device, including a bus, one or more processors, and one or more memories. The one or more memories communicate with the one or more processors via the bus and store machine-readable instructions that, when executable by the one or more processors, cause the one or more processors to receive, during a pre-scheduling period, feedback report information for pre-scheduling information from a terminal, and in response to the report information including the task requirement information, perform a scheduling operation based on the pre-scheduling grant information according to the task requirement information. The pre-scheduling information is generated based on scheduling grant information of last task transmission of the terminal.

### BRIEF DESCRIPTION OF THE DRAWINGS

FIG. 1 illustrates a schematic diagram showing a time sequence of a communication system for data interaction according to some embodiments of the present disclosure.

FIG. 2 illustrates a schematic flowchart of a data processing method according to some embodiments of the present disclosure.

FIG. 3 illustrates a schematic diagram showing a time sequence of a data processing method according to some embodiments of the present disclosure.

FIG. 4 illustrates a schematic flowchart of another data processing method according to some embodiments of the present disclosure.

FIG. 5 illustrates a schematic structural diagram of a data processing apparatus according to some embodiments of the present disclosure.

FIG. 6 illustrates a schematic structural diagram of an electronic device according to some embodiments of the present disclosure.

### DETAILED DESCRIPTION OF THE EMBODIMENTS

The technical solutions and features of the present disclosure are described according to the accompanying drawings.

Various modifications can be made to embodiments of the present disclosure. The specification is not considered limiting but is used as examples of embodiments of the present disclosure. Those skilled in the art can think of other modifications within the scope and spirit of the present disclosure.

Some accompanying drawings can be included in the specification, form a part of the specification, and show some embodiments of the present disclosure. The accompanying drawings can be used to describe the principle of the present disclosure with the general description of the present disclosure above and the detailed description of embodiments of the present disclosure below.

Embodiments of the present disclosure are described exemplarily according to the accompanying drawings. Features of the present disclosure can become obvious.

Although the present disclosure is described according to specific examples, those skilled in the art can implement many other equivalent forms of the present disclosure, which include features of the claims and are within the scope of the present disclosure.

In connection with the accompanying drawings and the following detailed description, the above and other aspects, features, and advantages of the present disclosure can become more obvious.

Embodiments of the present disclosure are described according to the accompanying drawings. However, embodiments of the present disclosure are merely examples of the present disclosure and can adopt a plurality of implementations. Well-known and/or repeated functions and structures are not described in detail to avoid unnecessary or redundant details that would obscure the present disclosure. Therefore, the specific structural and functional details of the present disclosure are not intended to limit the present disclosure, but are merely used as a basis and representative basis for teaching those skilled in the art to use the present disclosure in substantially any appropriate detailed structures.

In the specification, phrases such as “in one embodiment,” “in another embodiment,” “in yet another embodiment,” or “in other embodiments” can refer to one or more embodiments of same or different embodiments of the present disclosure.

When there is no conflict, embodiments of the present disclosure and features of embodiments can be grouped with each other. The present disclosure is described in detail in connection with the accompanying drawings and embodiments of the present disclosure.

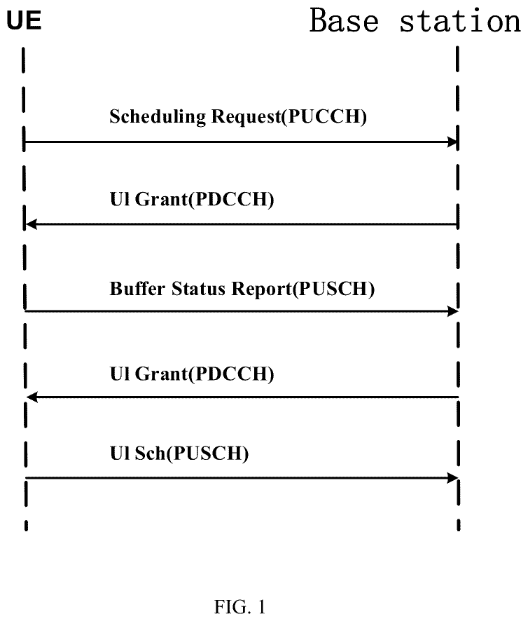

FIG. 1 illustrates a schematic diagram showing a time sequence of a communication system performing data interaction. As shown in FIG. 1, the communication system includes a base station and a terminal (i.e., user equipment (UE)). Data transmission can be performed between the base station and the terminal via wireless communication. In some embodiments, after the terminal accesses the base station, when uplink data needs to be sent for task transmission, an uplink scheduling request (SR) can be sent to the base station through a physical uplink control channel (PUCCH) to request uplink scheduling resources. Then, according to the scheduling request of the terminal, the base station can send uplink scheduling grant information (UI Grant) to the terminal and assign the scheduling resources such as uplink frequency resources. When the terminal sends the scheduling request, the data volume that needs to be sent is not identified. Thus, when the terminal needs to continue to send the uplink data, the terminal can send a buffer status report (BSR) using the assigned frequency resources via a physical uplink shared channel (PUSCH) according to the UI Grant to notify the base station the task requirement information such as the data volume that the base station needs to send. After receiving the BSR of the terminal, the base station can continue to send UI Grant to the terminal to assign corresponding frequency resources for the terminal. Thus, the terminal can continue to transmit data via PUSCH using the assigned scheduling resources to complete the uplink data transmission. Therefore, after the uplink data transmission ends, the base station can release the scheduling resources according to the interaction information. If the terminal subsequently triggers the uplink data transmission requests a plurality of times, the SR may need to be reported to the base station to request the scheduling resources the plurality of times. Thus, the base station may perform parsing on the scheduling requests a plurality of times. If the parsing of the scheduling request fails or the grant resources need to be reassigned, the processing efficiency of the base station can be low, which further extends the time for the uplink task to obtain the grant scheduling.

To solve the above technical problems, in the present disclosure, after the terminal stops the task data transmission, pre-scheduling can continue by receiving the feedback report information for the prescheduling information from the terminal during the pre-scheduling. If the report information during the pre-scheduling includes task request information of the terminal, the corresponding scheduling resources can be assigned to perform a scheduling operation based on the pre-scheduling grant information according to the task request information. Thus, the terminal can transmit the uplink data to the base station based on the assigned scheduling resources.

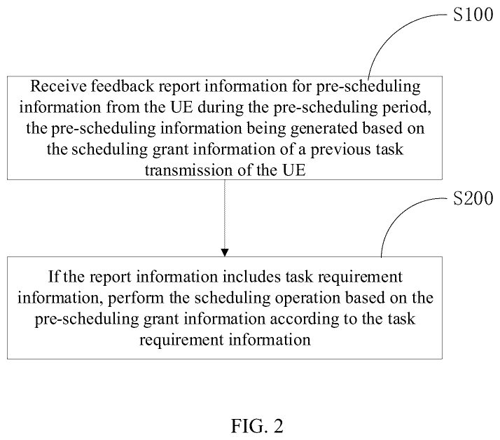

FIG. 2 illustrates a schematic diagram showing a time sequence of a communication system for data interaction according to some embodiments of the present disclosure. As shown in FIG. 2, the method includes the following steps.

At S100, feedback report information for pre-scheduling information is received from the terminal during the pre-scheduling period. This pre-scheduling information is generated based on the scheduling grant information of a previous task transmission of the terminal.

At S200, if the report information includes task requirement information, the scheduling operation is performed based on the pre-scheduling grant information according to the task requirement information.

In some embodiments, the pre-scheduling period can be set based on the time when the terminal stops the task and can be a time period after the terminal stops the task. The time length of the pre-scheduling time period can be set by a technician according to experience. In some other embodiments, the pre-scheduling period can also be set according to application situations such as terminal connection quantity in an application.

For example, the base station can send the corresponding scheduling grant information according to the terminal scheduling request. The scheduling grant information can include the scheduling resources assigned by the base station for the terminal. Thus, the terminal can perform data transmission according to the assigned scheduling resources. Moreover, the base station can determine the data that the terminal needs to send according to the interaction information sent by the terminal and determine whether the uplink data transmission is completed. When the uplink data transmission is determined to be completed, the terminal can stop the task. Then, a time period can be set according to the time when the terminal stops the task as the pre-scheduling period. The task stopped by the terminal can be the last task transmission process. The base station can send the pre-scheduling information to the terminal to perform pre-scheduling during the pre-scheduling period.

The pre-scheduling information can include the scheduling grant information actively sent by the base station to the terminal when the terminal stops the task. The pre-scheduling information can be generated according to the scheduling grant information corresponding to the scheduling request of the last task transmission of the terminal. In some embodiments, according to the scheduling grant information such as the frequency resources required by the terminal to perform transmission on the uplink data with a smallest data volume when the terminal performs the last task transmission, the base station can determine the scheduling grant information such as the frequency resources required when the current terminal performs the data transmission with the smallest volume. Thus, the pre-scheduling information can be generated. After the terminal receives the pre-scheduling information, according to whether the terminal has uplink data to transmit, the terminal can feedback the report information with or without the task requirement information. After receiving the report information of the terminal, the base station can perform analysis. If the report information includes the task requirement information, for example, the data volume of the uplink data sent by the terminal, the base station can perform the scheduling operation according to the task requirement information and the pre-scheduling information. For example, the scheduling resources such as the frequency resources for the data transmission can be assigned for the base station to cause the terminal to perform the data transmission according to the scheduling resources assigned by the scheduling operation.

The beneficial effects of embodiments of the present disclosure can be as follows. The feedback report information for the pre-scheduling information can be received from the terminal during the pre-scheduling period, and the corresponding scheduling operation can be determined according to the report information. Thus, when the terminal starts the data transmission again, the base station may not need to parse the scheduling request and can directly perform the task scheduling, which saves the signal cost, reduces task delay, and improves processing efficiency.

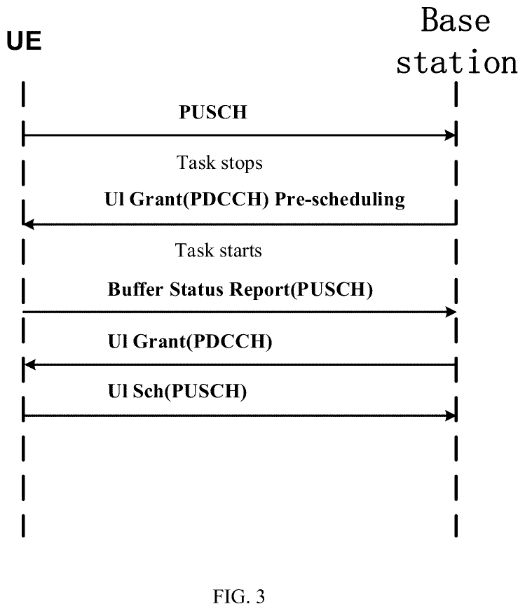

FIG. 3 illustrates a schematic diagram showing a time sequence of a data processing method according to some embodiments of the present disclosure. As shown in FIG. 3, after the terminal task is stopped, the base station actively sends the pre-scheduling information to the terminal via the Physical downlink control channel (PDCCH) during the pre-scheduling period. The pre-scheduling information can be the UI grant corresponding to when the terminal performs the previous task transmission. The pre-scheduling information can be set according to the data transmission task with the smallest volume to avoid wasting the air interface resources. After the terminal receives the pre-scheduling information, when the uplink data transmission is needed, the terminal can send the BSR via the PUSCH to notify the base station of the task requirement information such as the data volume that needs to be sent. Then, the base station can directly perform task scheduling according to the task requirement information and the pre-scheduling information, including the frequency resources assigned to the terminal. The base station can also send the UI grant to cause the terminal to be able to perform the uplink data transmission based on scheduling resources assigned for the scheduling operation.

In some embodiments, the data processing method can further include the following processes.

If the report information does not include the task requirement information during the pre-scheduling period, the scheduling resources corresponding to the scheduling grant information can be released. In some embodiments, the base station can actively send the pre-scheduling information one time or a plurality of times to the terminal during the pre-scheduling period to assign the corresponding scheduling resources for the terminal to perform the uplink data transmission. For the plurality of times, after the terminal receives the pre-scheduling information once, if no uplink data needs to be sent, the uplink scheduling resources configured to perform the uplink data transmission assigned according to the pre-scheduling information can be determined to have leftover, and the corresponding report information can be sent to the base station. The base station can perform analysis after receiving the report information of the terminal. If the report information does not include the task requirement information such as the transmission volume of the uplink data transmission that the terminal needs to perform, the base station can continue to send the pre-scheduling information during the pre-scheduling period. When the pre-scheduling period ends, if all pieces of report information do not include the task requirement information, the base station can determine that the terminal does not have the need to perform the task data transmission again. The resources of the terminal assigned according to the scheduling grant information corresponding to the last scheduling request can be released for other terminals to use.

In some embodiments, the setting method of the pre-scheduling period can include the following processes.

The time length of the pre-scheduling period can be set according to the maximal pre-scheduling time length and the minimal pre-scheduling time length. In some embodiments, the maximal pre-scheduling time length and the minimal pre-scheduling time length can be set according to the experience of the technician or the actual situation. For example, when the maximal pre-scheduling time length and the minimal pre-scheduling time length are set for the first time, the technician can estimate according to the possible feedback task requirement information of the terminal and then perform the setting. In the subsequent interaction between the base station and the terminal, if the maximal pre-scheduling time length and the minimal pre-scheduling time length cannot satisfy the requirement of the actual situation, for example, the base station may often receive the scheduling request of the terminal in a short time period after exceeding the maximal pre-scheduling time length, the maximal pre-scheduling time length may not be able to satisfy the need of the terminal. Thus, the maximal pre-scheduling time length can be modified and set according to the actual situation by correspondingly adding some time. After determining the maximal pre-scheduling time length and the minimal pre-scheduling time length, the base station can set a relatively small time length for the pre-scheduling period according to the middle value between the maximal pre-scheduling time length and the minimal pre-scheduling time length, which can prevent the air interface resources from being wasted. The starting time of the pre-scheduling period can be the stopping time of the task of the terminal.

The ending time can be calculated according to the set time length.

To further adjust the pre-scheduling period of the terminal, the data processing method of embodiments of the present disclosure can include obtaining history report information of the terminal, determining distribution information of the task requirement information included in the history report information, and determining an adjustment strategy for the time length of the pre-scheduling period based on the distribution information. In embodiments of the present disclosure, the adjustment strategy can be determined according to the history report information after the task of the terminal is terminated a plurality of times. In some embodiments, for the report information sent by the terminal a plurality of times after terminating the task one time, if all the report information does not include the task requirement information, the report information after the task is terminated this time can be determined to not include the task requirement information in the history report information. If the report information including the task requirement information exists, the report information after terminating the task this time can be determined to include the task requirement information in the history report information. That is, statistics can be performed on the history report information according to the feedback situation of all the report information corresponding to the situation after the task of the terminal is terminated.

In some embodiments, the history report information can include the task requirement information and the distribution information, which can be used to look up the distribution situation of the history report information including or not including the task requirement information. The distribution can include the ratio of the report information including the task requirement information to the history report information, which can be used to indicate the possibility of the terminal performing the data transmission again after the task is terminated. Since a relatively small time length is adopted according to the maximal pre-scheduling time length and the minimal pre-scheduling time length, if the distribution information indicates the feedback report information including the task requirement information from the terminal, the report information including the task requirement information can have a relatively large ratio in the history report information. Thus, the possibility for the terminal to perform the data transmission again in the pre-scheduling period after the task is terminated can be relatively large. Then, the corresponding adjustment strategy can be determined based on the distribution information. The time length of the pre-scheduling period can be added. Thus, the base station can directly perform scheduling when the terminal continues to perform data transmission and assign the scheduling resources. On the contrary, if the distribution information indicates that the feedback report information including the task requirement information from the terminal has a relatively small ratio in the history report information. Then, the possibility for the terminal to perform the data transmission again after the task is terminated can be relatively small. Thus, the corresponding adjustment strategy can be determined based on the distribution information to reduce the time length of the pre-scheduling period to avoid resource waste.

In some embodiments, determining the adjustment strategy for the pre-scheduling period based on the distribution information can include, if the distribution information can indicate that the history report information does not include the task requirement information, reducing the time length of the pre-scheduling period according to the first adjustment strategy and the minimal pre-scheduling time length. In some embodiments, if the distribution information indicated that the history report information of the terminal, the report information including the task requirement information may be never fed back. Thus, the possibility for the terminal to perform the data transmission again in the pre-scheduling period after the task is terminated can be very small. Then, the time length of the pre-scheduling period can be reduced based on the distribution information and according to the first adjustment strategy and the minimal pre-scheduling time length, until the time length is reduced to the minimal pre-scheduling time length. Thus, the base station can send the pre-scheduling information to perform pre-scheduling based on the relatively small pre-scheduling period after the terminal stops the task one time. The first adjustment strategy can include a predetermined time length adjustment interval. The time length can be reduced according to the time length adjustment interval. In some embodiments, if the time length of the current pre-scheduling period is the minimal pre-scheduling time length, the minimal pre-scheduling time length can be adjusted first. According to the time length adjustment interval of the minimal pre-scheduling time length, the minimal pre-scheduling time length can be reduced. Then, according to the adjusted minimal pre-scheduling time length and the time length adjustment interval corresponding to the first adjustment strategy, the time length of the pre-scheduling period can be reduced.

In some embodiments, determining the adjustment strategy for the pre-scheduling period based on the distribution information can further include, if the distribution information indicates that the ratio of the report information including the task requirement information satisfies the predetermined condition, adding the time length of the pre-scheduling period according to the second adjustment strategy and the maximal pre-scheduling time length, and if the distribution information indicates that the ratio of the report information including the task requirement information does not satisfy the predetermined condition, maintaining the time length of the pre-scheduling period. In some embodiments, if the distribution information indicates that the terminal fed back the report information including the task requirement information in the history report information, the predetermined condition can be set according to the ratio of the report information including the task requirement information to the history report information to distinguish the situation when the possibility for the terminal to perform the data transmission again is relatively large after the task is terminated. The predetermined condition can be set according to the experience of the technician or the actual situation. For example, the predetermined condition can be not smaller than 60%. That is, when the ratio reaches or exceeds 60%, the predetermined condition can be satisfied.

In some embodiments, if the distribution information indicates that the ratio of the report information including the task requirement information satisfies the pre-determined condition. That is, the possibility for the terminal to perform the data transmission again after the task is terminated can be very large. Then, the time length of the pre-scheduling period can be added according to the second adjustment strategy and the maximal pre-scheduling time length, until the time length reaches the maximal pre-scheduling time length. Thus, the base station can send the pre-scheduling information to perform the pre-scheduling based on the relatively large pre-scheduling period after the terminal terminates the task the next time. The second adjustment strategy can include the predetermined time length interval. The time length can be added according to the time length adjustment interval. In some embodiments, if the time length of the current pre-scheduling period is determined to be the maximal pre-scheduling time length, the maximal pre-scheduling time length can be adjusted first. The maximal pre-scheduling time length can be increased according to the time length adjustment interval of the maximal pre-scheduling time length. Then, the time length of the pre-scheduling period can be increased according to the adjusted maximal pre-scheduling time length and the time length adjustment interval corresponding to the second adjustment strategy.

If the distribution information indicates that the report information including the task requirement information does not satisfy the pre-determined condition, e.g., less than 60% based on the above embodiments. That is, the possibility for the terminal to perform the data transmission after the task is terminated may not reach the predetermined value. Then, the time length of the current pre-scheduling period may not be adjusted, and the time length of the pre-scheduling period can be maintained. The base station can still send the pre-scheduling information to perform the pre-scheduling based on the same pre-scheduling period after the terminal stops the next task.

FIG. 4 illustrates a schematic flowchart of another data processing method according to some embodiments of the present disclosure. As shown in FIG. 4, after setting the minimal pre-scheduling time length during the initialization, the base station can determine whether all feedback report information (M>1) of the terminal for the pre-scheduling information after the task is terminated M times reports the padding information.

If the report information reports the padding information, whether the time length of the pre-scheduling period is greater than the minimal pre-scheduling time length can be determined. If the time length of the pre-scheduling period is greater than the minimal pre-scheduling time length, the time length of the current pre-scheduling period can be lowered for a level according to the time length adjustment interval of the first adjustment strategy. If the time length of the pre-scheduling period is not greater than the minimal pre-scheduling time length, the minimal pre-scheduling time length can be adjusted to a smaller time length. Then, the method can return to the step of determining whether the time length of the pre-scheduling period is greater than the minimal pre-scheduling time length to perform the subsequent operations.

If not all report information is padding information, i.e., the terminal has reported new BSR including the task requirement information, the base station can determine whether the number of times that the BSR is reported by the terminal for the pre-scheduling information after the terminal stops the task M times reaches N times (N>0, M≥N). N can be determined based on the ratio corresponding to the predetermined condition. If N is not reached, the time length of the pre-scheduling period can remain unchanged. If N is reached or exceeded, whether the time length of the pre-scheduling period is smaller than the minimal pre-scheduling time length can be determined. If the time length of the pre-scheduling period is smaller than the minimal pre-scheduling time length, the time length of the current pre-scheduling period can be increased according to the time length adjustment interval of the second adjustment strategy. If the time length of the pre-scheduling period is not smaller than the minimal pre-scheduling time length, the maximal pre-scheduling time length can be first adjusted to a greater time length. Then, the method can return to the previous step of determining whether the time length of the pre-scheduling period is smaller than the maximal pre-scheduling time length to perform the subsequent operations.

In some embodiments, the data processing method can further include the following steps.

When the scheduling requests of other terminals are received, the scheduling requests of the other terminals can be processed first. In some embodiments, the base station can assign the priority for sending the pre-scheduling information to perform the pre-scheduling operation. The priority of performing the scheduling operation for the scheduling request can be higher than the priority of the pre-scheduling operation that is actively sent. In some embodiments, when the base station receives the scheduling requests of other terminals, the base station can first perform the scheduling operation according to the scheduling request to assign corresponding scheduling resources for the other terminals to satisfy the requirement of the other terminals performing the uplink data transmission. Then, the base station can perform the pre-scheduling operation according to the remaining resources after the assignment to send the pre-scheduling information to the terminal. Thus, the priority of the base station sending the pre-scheduling information to perform the pre-scheduling operation can be behind the priority of the scheduling request. Thus, the pre-scheduling operation may not occupy the useful air interface resources, which avoids affecting the time for the other terminals to obtain the scheduling grant and perform the data transmission to improve the resource utilization efficiency.

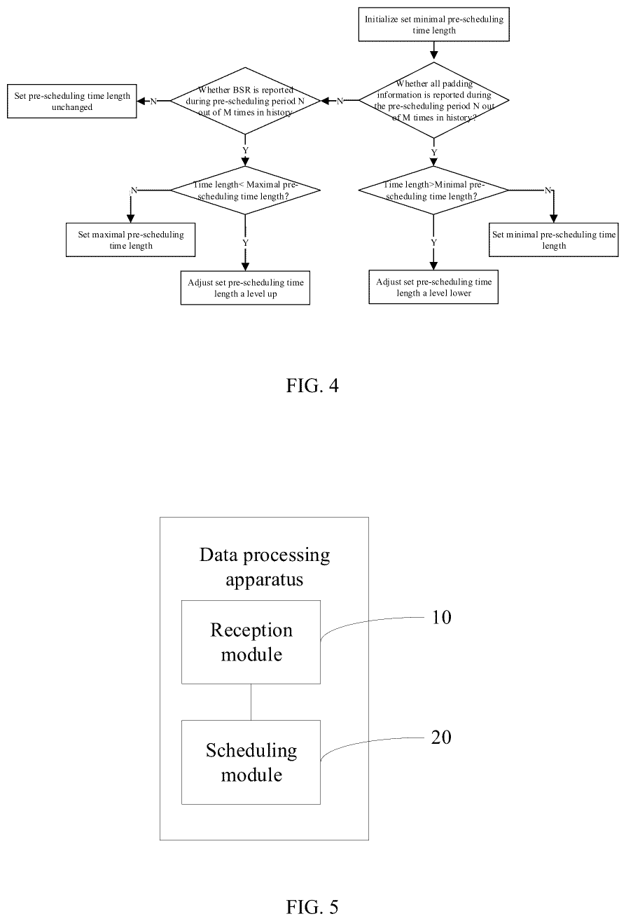

Embodiments of the present disclosure further provide a data processing apparatus. As shown in FIG. 5, the data processing apparatus includes a reception module 10 and a scheduling module 20.

The reception module 10 can be configured to receive the feedback report information for the pre-scheduling information from the terminal during the pre-scheduling period. The pre-scheduling information can be generated based on the scheduling grant information of the last task transmission of the terminal.

The scheduling module 20 can be configured to, if the report information includes the task requirement information, perform the scheduling operation based on the pre-scheduling grant information according to the task requirement information.

In some embodiments, the data processing apparatus can further include an adjustment module (not shown in the figure).

The adjustment module can be configured to obtain the history report information of the terminal, determine the distribution information of the report information including the task requirement information in the history report information, and determine the adjustment strategy for the time length of the pre-scheduling period based on the distribution information.

In the data processing apparatus of embodiments of the present disclosure, through the reception module 10, the scheduling module 20, and the adjustment module, the steps of the data processing methods of embodiments of the present disclosure can be implemented, which are not repeated here.

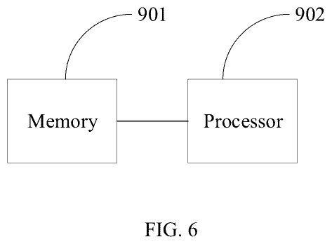

Embodiments of the present disclosure further provide an electronic device, including at least a memory 901, a processor 902, and a bus (not shown in the figure). The structure of the electronic device is shown in FIG. 6. Memory 901 stores machine-readable instructions that can be executed by processor 902. When the electronic device is running, the processor 902 can communicate with the memory 901 through the bus. When the machine-readable instructions are executed by the processor, the processor can be configured to perform the steps of the data processing methods of embodiments of the present disclosure.

Since the electronic device of embodiments of the present disclosure includes the memory of implementing the data processing methods of embodiments of the present disclosure, those skilled in the art can know the structure and variations of the electronic device of embodiments of the present disclosure, which are not repeated here.

Embodiments of the present disclosure further provide a computer-readable storage medium. The computer-readable storage medium can store computer-executable instructions.

When the computer-executable instructions in the computer-readable storage medium are executed, the steps of the data processing methods of embodiments of the present disclosure can be implemented.

Those skilled in the art should understand that embodiments of the present disclosure can be provided as the methods, the electronic device, the computer-readable storage medium, or the computer program product. Thus, the present disclosure can adopt hardware embodiments, software embodiments, or a combination thereof. Moreover, the present disclosure can be implemented in the form of a computer program product implemented on one or more computer-readable storage media containing computer-executable program codes. When the present disclosure is implemented via software, the functions can be stored in a computer-readable medium or transmitted as one or more instructions or codes of the computer-readable medium.

The above processor can be a general-purpose processor, a digital signal processor, an application-specific integrated circuit (ASIC), a programmable logic device (PLD), or a combination thereof. The PLD can include a complex programmable logic device (CPLD), a field-programmable gate array (FPGA), a generic array logic (GAL), or any combination thereof. The general-purpose processor can be a microprocessor or any conventional processor, etc.

The above memory can include non-permanent storage in the computer-readable medium, random-access memory (RAM), and/or non-volatile memory, such as read-only memory (ROM) or flash memory. The memory can be an example of the computer-readable medium.

The above readable storage medium can include magnetic disks, optical disks, DVDs, USB, read-only storage memory (ROM), or random-access memory (RAM). The forms of the storage medium may not be limited in the present disclosure.

The flowcharts and diagrams of the accompanying drawings illustrate the architecture, functionality, and operations that can be implemented according to the systems, methods, and computer program products of embodiments of the present disclosure. Each block of the flowcharts or diagrams can represent a module, a program segment, or a part of codes. The module, program segment, or a part of codes can include one or more executable instructions used to implement the determined logic functions. In some other embodiments, the functions marked in the blocks can occur in an order different from the order illustrated in the accompanying drawings. For example, the blocks represented by two grounds can be performed in parallel or in a reverse order, which depends on the involved functions. Each block of the diagram and/or the flowchart and the combination of blocks of the diagram and/or the flowchart can be implemented by a special purpose hardware-based system configured to execute the determined function or operations, or by a combination of the special purpose hardware and the computer instructions.

The above are only exemplary embodiments of the present disclosure and an explanation of the technical principles adopted. Those skilled in the art should understand that the scope of the present disclosure involved is not limited to the technical solution formed by the specific combination of the technical features described above, but also covers other technical solutions formed by arbitrary combination of the above technical features or equivalent features without departing from the concept of the present disclosure, for example, the technical solution formed by performing mutual substitution on the above features and technical features disclosed in the present disclosure (but not limited to).

Furthermore, although operations are described in a specific order, they should not be interpreted as requiring the operations to be performed in a specific order or sequentially. In some environments, multitasking and parallel processing can be advantageous. Similarly, although several specific details are included in the above description, these details should not be used to describe the limitation of the scope of the present disclosure. Some features described in the contexts of the individual embodiments can be combined and implemented in the individual embodiments. On the contrary, multiple features in embodiments of the present disclosure can be implemented in a plurality of embodiments individually or in any appropriate subset.

Although the subject matter is described using language specific to structural features and/or methodological actions, the subject matter defined in the appended claims may not be necessarily limited to the specific features or actions described above. On the contrary, the specific features and actions are examples of implementing the appended claims.

The above are some embodiments of the present disclosure and are not used to limit the present disclosure. The scope of the present disclosure can be subject to the appended claims. Those skilled in the art can make modifications or equivalent replacements to embodiments of the present disclosure. These modifications and the equivalent replacements are within the scope of the present disclosure.

What is claimed is:

1. A data processing method comprising:
receiving, during a pre-scheduling period, feedback report information for pre-scheduling information from a terminal, the pre-scheduling information being generated based on scheduling grant information of last task transmission of the terminal; and
in response to the report information including the task requirement information, performing a scheduling operation based on the pre-scheduling grant information according to the task requirement information.

2. The method according to claim 1, further comprising:
in response to the report information during the pre-scheduling period not including the task requirement information, releasing scheduling resources corresponding to the scheduling grant information.

3. The method according to claim 1, wherein setting the pre-scheduling period includes:
setting a time length for the pre-scheduling period according to a maximal pre-scheduling time length and a minimal pre-scheduling time length.

4. The method according to claim 3, further comprising:
obtaining history reporting information from the terminal;
determining distribution information of the report information including the task requirement information in the history reporting information; and
determining an adjustment strategy for a time length of the pre-scheduling period based on the distribution information.

5. The method according to claim 4, wherein determining the adjustment strategy for the pre-scheduling period based on the distribution information includes:
in response to the distribution information indicating that the history report information does not include the task requirement information, reducing the time length of the pre-scheduling period according to the first adjustment strategy and the minimal pre-scheduling time length.

6. The method according to claim 5, wherein determining the adjustment strategy for the pre-scheduling period based on the distribution information further includes:
in response to the distribution information indicating that a ratio of including the task requirement information satisfies a predetermined condition, extending the time length of the pre-scheduling period according to as second adjustment strategy and the maximal pre-scheduling time length; and
in response to the distribution information indicating that a ratio of including the task requirement information does not satisfy a predetermined condition, keeping the time length of the pre-scheduling period unchanged.

7. The method according to claim 1, further comprising:
in response to receiving a scheduling request of another terminal, processing the scheduling request of the another terminal with priority.

8. A data processing apparatus comprising:
a reception module configured to receive, during a pre-scheduling period, feedback report information for pre-scheduling information from a terminal, the pre-scheduling information being generated based on scheduling grant information of last task transmission of the terminal; and
a scheduling module configured to, in response to the scheduling module report information including the task requirement information, perform a scheduling operation based on the pre-scheduling grant information according to the task requirement information.

9. The apparatus according to claim 8, wherein the scheduling module is further configured to:
in response to the report information during the pre-scheduling period not including the task requirement information, release scheduling resources corresponding to the scheduling grant information.

10. The apparatus according to claim 8, wherein the scheduling module is further configured to:
set a time length for the pre-scheduling period according to a maximal pre-scheduling time length and a minimal pre-scheduling time length.

11. The apparatus according to claim 8, further comprising an adjustment module configured to:
obtain history reporting information from the terminal;
determine distribution information of the report information including the task requirement information in the history reporting information; and
determine an adjustment strategy for a time length of the pre-scheduling period based on the distribution information.

12. The apparatus according to claim 11, wherein the adjustment module is further configured to:
in response to the distribution information indicating that the history report information does not include the task requirement information, reduce the time length of the pre-scheduling period according to the first adjustment strategy and the minimal pre-scheduling time length.

13. The apparatus according to claim 12, wherein the adjustment module is further configured to:
in response to the distribution information indicating that a ratio of including the task requirement information satisfies a predetermined condition, extend the time length of the pre-scheduling period according to as second adjustment strategy and the maximal pre-scheduling time length; and
in response to the distribution information indicating that a ratio of including the task requirement information does not satisfy a predetermined condition, keep the time length of the pre-scheduling period unchanged.

14. An electronic device comprising:
a bus;
one or more processors; and
one or more memories communicating with the one or more processors via the bus and storing machine-readable instructions that, when executable by the one or more processors, cause the one or more processors to:
receive, during a pre-scheduling period, feedback report information for pre-scheduling information from a terminal, the pre-scheduling information being generated based on scheduling grant information of last task transmission of the terminal; and
in response to the report information including the task requirement information, perform a scheduling operation based on the pre-scheduling grant information according to the task requirement information.

15. The device according to claim 14, wherein the one or more processors are further configured to:
in response to the report information during the pre-scheduling period not including the task requirement information, release scheduling resources corresponding to the scheduling grant information.

16. The device according to claim 14, wherein the one or more processors are further configured to:
set a time length for the pre-scheduling period according to a maximal pre-scheduling time length and a minimal pre-scheduling time length.

17. The device according to claim 14, wherein the one or more processors are further configured to:
obtain history reporting information from the terminal;
determine distribution information of the report information including the task requirement information in the history reporting information; and
determine an adjustment strategy for a time length of the pre-scheduling period based on the distribution information.

18. The device according to claim 17, wherein the one or more processors are further configured to:
in response to the distribution information indicating that the history report information does not include the task requirement information, reduce the time length of the pre-scheduling period according to the first adjustment strategy and the minimal pre-scheduling time length.

19. The device according to claim 18, wherein the one or more processors are further configured to:
in response to the distribution information indicating that a ratio of including the task requirement information satisfies a predetermined condition, extend the time length of the pre-scheduling period according to as second adjustment strategy and the maximal pre-scheduling time length; and
in response to the distribution information indicating that a ratio of including the task requirement information does not satisfy a predetermined condition, maintain the time length of the pre-scheduling period unchanged.

20. The device according to claim 14, wherein the one or more processors are further configured to:
in response to receiving a scheduling request of another terminal, process the scheduling request of the another terminal with priority.
